(19) United States
(12) Patent Application Publication
(10) Pub. No.: US 2009/0081539 A1
(43) Pub. Date: Mar. 26, 2009

(54) Battery pack

(76) Inventors: Seok Koh, Yongin-si (KR); Kyungwon Seo, Yongin-si (KR); Jeongdeok Byun, Yongin-si (KR); Kyungho Park, Yongin-si (KR); Eunok Kwak, Yongin-si (KR)

Correspondence Address: ROBERT E. BUSHNELL & LAW FIRM, 2029 K STREET NW, SUITE 600, WASHINGTON, DC, 20006-1004, US

(21) Appl. No.: 12/219,221

(22) Filed: Jul. 17, 2008

(30) Foreign Application Priority Data
Sep. 21, 2007 (KR) 10-2007-0097035

(51) Int. Cl. H01M 2/02; H01M 2/00

(52) U.S. Cl. 429/178; 429/163

(57) ABSTRACT

A battery pack increases coupled strength of a protection circuit module and an outer case, and realize a compact battery pack by physically coupling the protection circuit module coupled to a bare cell and the integral outer case by an adherent member. The battery pack includes a bare cell; a circuit module arranged on an upper surface of the bare cell and electrically coupled to the bare cell; an outer case integrally formed so as to cover a pair of short side surfaces and the upper surface of the bare cell including the circuit module, and coupled to the circuit module; and a label attached to the pair of the short side surfaces, a pair of long side surfaces and a lower surface of the bare cell. At least one protrusion part may be integrally formed an outer side surface of said circuit module. At least one tapered part may be integrally formed with said outer case.

### CLAIM OF PRIORITY

This application makes reference to, incorporates the same herein, and claims all benefits accruing under 35 U.S.C. §119 from an application for BATTERY PACK earlier filed in the Korean Intellectual Property Office on 21 Sep. 2007 and there duly assigned Serial No. 2007-0097035.

### BACKGROUND OF THE INVENTION

1. Field of the Invention

The present invention relates to a battery pack, and more particularly, to a battery pack that can increase production yield by reducing a defective ratio of products and be compacted.

2. Description of the Related Art

Generally, with the development of light weighted and high functionality portable wireless devices such as video cameras, cellular phones, portable computers, and other relate devices, secondary battery used as the main power supply of these portable electronic devices has been actively developed and produced. For example, the secondary battery includes a nickel-cadmium battery, a nickel-hydrogen battery, a nickel-zinc battery and a lithium secondary battery, and other related batteries. Among them, the lithium secondary battery has been widely used for up-to-date electronic device fields because the lithium secondary battery may be recharged and the size of the battery may be minimized so as to have large capacity, a high operating voltage and high energy density per unit weight.

After safety devices such as a PTC (positive temperature coefficient) element, a thermal fuse and a protection circuit module(hereinafter, referred to as “PCM”), and other related safety devices, are mounted on a bare cell sealing an electrode assembly including a positive electrode plate, a negative electrode plate and a separator, a can receiving the electrode assembly, and an upper opening of the can with a cap assembly, a battery pack is formed by receiving the above stated elements in an separate outer case, or filling cavities with a hot-melt resin and tubing with thin outer material and labeling.

The safety devices are electrically connected to a positive electrode terminal and a negative electrode terminal by conductive lead plates so as to prevent firing or explosion of the battery by interrupting an unexpected electric current when the internal temperature of the battery becomes high than a predetermined temperature or a voltage is increased by an over-charge, or other related conditions.

A contemporary battery pack includes a core pack including a bare cell having an electrode terminal protruded toward one short side surface so as to be charged and discharged and a protection circuit module coupled to an upper part of the bare cell; an outer cover pre-formed and assembled on both side parts of the core pack; and a resin member formed so as to fix the protection circuit module on the bare cell by injecting hot-melt resin to an upper region of the core pack coupled to the outer cover, i.e., between the upper part of the bare cell and the protection circuit module.

The contemporary battery pack uses the hot-melt resin so as to form the resin molding part fixing the protection circuit module on the bare cell. When outer appearance of the battery pack is formed by a hot-melting method using the hot-melt resin, a defective ratio of outer appearance becomes high because of material defective properties, for example air bubble, produced in the hot-melt resin. Since the resin member is formed between the bare cell and the protection circuit module so as to fix the protection circuit module onto the bare cell, the battery pack including the bare cell and the protection circuit module should be disused when defective outer appearance of the resin member occurs. Accordingly, there is a problem that a defective ratio of the battery pack is increased.

There is another problem that material costs are increased because the related art battery pack needs a high quantity of the hot-melt resin injected between the bare cell and the protection circuit module so as to form the resin molding part.

There is still another problem that manufacturing costs are increased, and the manufacturing processes become complicated because the contemporary battery pack needs a separate mold to form the resin member when using the hot-melt method.

There is again another problem that the compactness of a battery pack is difficult to be realized because the contemporary battery pack forms the outer appearance by assembling a separate outer cover on both side parts of the core pack and forming the resin member on an upper part of the core pack by the hot-melt method.

### SUMMARY OF THE INVENTION

It is therefore an object of the present invention to provide an improved battery pack to overcome the problems of the contemporary battery pack.

It is another object of the present invention to provide a battery pack that can increase coupling strength between a protection circuit module and an outer case, and realize a compact battery pack by physically coupling the protection circuit module coupled to a bare cell to the integral outer case by an adherent member.

It is again another object of the present invention to provide a battery pack that can realize higher production yield by reducing a defective ratio of the battery pack than a related art battery pack forming an outer case to fix the protection circuit module on the bare cell by the hot-melt method, simplify complicated manufacturing processes caused by the hot-melting method, and reduce material costs of the hot-melt resin.

Additional advantages, objects and features of the invention will be set forth in part in the description which follows and in part will become apparent to those having ordinary skill in the art upon examination of the following or may be learned from practice of the invention.

According to one aspect of the present invention, there is provided a battery pack, which includes a bare cell; a circuit module arranged on an upper surface of the bare cell and electrically coupled to the bare cell; an outer case integrally formed so as to cover a pair of short side surfaces and the upper surface of the bare cell including the circuit module, and coupled to the circuit module; and a label attached to the pair of the short side surfaces, a pair of long side surfaces and a lower surface of the bare cell.

The circuit module may be coupled to the outer case by an adherent member including a plurality of protrusion parts formed on the circuit module and a plurality of receiving grooves formed on the outer case corresponding to the protrusion parts of the circuit module so as to enable the plurality of the protrusion parts of the circuit module to be inserted in the plurality of the receiving grooves.

The circuit module may include a plate-shaped printed circuit board, an outer terminal part installed to the printed circuit board so as to be exposed to the outside, and the plurality of the protrusion parts formed on an outer side surface of the printed circuit board.

At least one of the protrusion parts may be located so as to correspond to a region where the outer terminal part is located.

The plurality of the protrusion parts may be protruded in tapered shape from the outer side surface of the printed circuit board toward outer direction.

Thickness of the plurality of the protrusion parts protruded from the outer side surface of the printed circuit board to the exterior of the battery may be in a range of ⅔ to 3/3 of thickness of the receiving grooves formed in the outer case.

The outer case may include a front surface part formed to have size corresponding to the upper surface of the bare cell provided with the circuit module, side surface parts connected to the front surface part and formed to have size corresponding to the pair of the respective short side surfaces of the bare cell, an extended surface part formed to be extended from edges of the front surface part and the side surface part so as to cover the pair of the long side surfaces of the bare cell, and a plurality of receiving grooves formed at a position corresponding to the protrusion parts of the circuit module in an inner side of the extended surface part adjacent to the front surface part.

The circuit module may be coupled to the outer case by the adherent member formed in an inner side of the outer case. The adherent member may include a plurality of tapered parts located in a front end of the outer case in inserted direction of the circuit module so as to guide the circuit module, and receiving space located in a rear end of the outer case so as to fix the circuit module.

The circuit module may include a plate-shaped printed circuit board and an outer terminal part installed on the printed circuit board so as to be exposed to the outside.

At least one of the tapered parts may be located on a portion of the outer terminal part included in the circuit module.

The outer case may include the front surface part formed to have a size corresponding to the upper surface of the bare cell provided with the circuit module, the side surface part connected to the front surface part and formed to have the size corresponding to the pair of the respective short side surfaces of the bare cell, the extended surface part formed to be extended from the edges of the front surface part and the side surface part so as to cover the pair of the long side surfaces of the bare cell, a plurality of tapered parts formed to have an inclined surface and a plane connected to the inclined surface in an inner side of the extended surface part adjacent to the front surface part, and the receiving space formed on an upper part of the tapered parts in an inner side of the extended surface part adjacent to the front surface part.

The battery pack may additionally include an adherent insulating member attached onto the upper surface of the bare cell so as to prevent an electrical short of the bare cell and the circuit module.

The bare cell may be electrically coupled to the circuit module by one electrical connecting terminal installed on the circuit module, a first lead tab electrically coupling a protruded electrode terminal insulated from one of a pair of short side surfaces of the bare cell, and a second lead tab electrically coupling another electrical connecting terminal installed on the circuit module to the other short side surface of the bare cell.

The outer case may include a handle part formed in a lower end of one side surface part corresponding to one of a pair of short side surfaces of the bare cell.

The label may include a hole formed on a region corresponding to the handle part.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view illustrating a completed battery pack constructed according to one exemplary embodiment of the present invention;

FIG. 2 is an exploded perspective view illustrating an exploded battery pack as shown in FIG. 1;

FIG. 3 is an exploded perspective view illustrating a bare cell of the battery pack shown in FIG. 2;

FIG. 4 is a perspective view illustrating a coupled state of a bare cell and a circuit module in the battery pack shown in FIG. 2;

FIG. 5 is a partial perspective view explaining coupling of a circuit module and an outer case shown in FIG. 2;

FIG. 6 is a partial cross-sectional view illustrating a part of a coupling section of a circuit module and an outer case taken along line A-A′ in FIG. 1;

FIG. 7 is a partial exploded perspective view illustrating a battery pack according to another exemplary embodiment of the present invention;

FIG. 8 is a partial perspective view explaining coupling of the circuit module and the outer case of FIG. 7; and

FIG. 9 is a partial cross-sectional view illustrating a part of a coupling section of a circuit module and an outer case taken along line B-B′ in FIG. 7.

### DETAILED DESCRIPTION OF THE INVENTION

Hereinafter, preferred embodiments of the present invention will be described in detail with reference to the accompanying drawings. The aspects and features of the present invention and methods for achieving the aspects and features will be apparent by referring to the embodiments to be described in detail with reference to the accompanying drawings. The present invention, however, is not limited to the embodiments disclosed hereinafter, but may be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

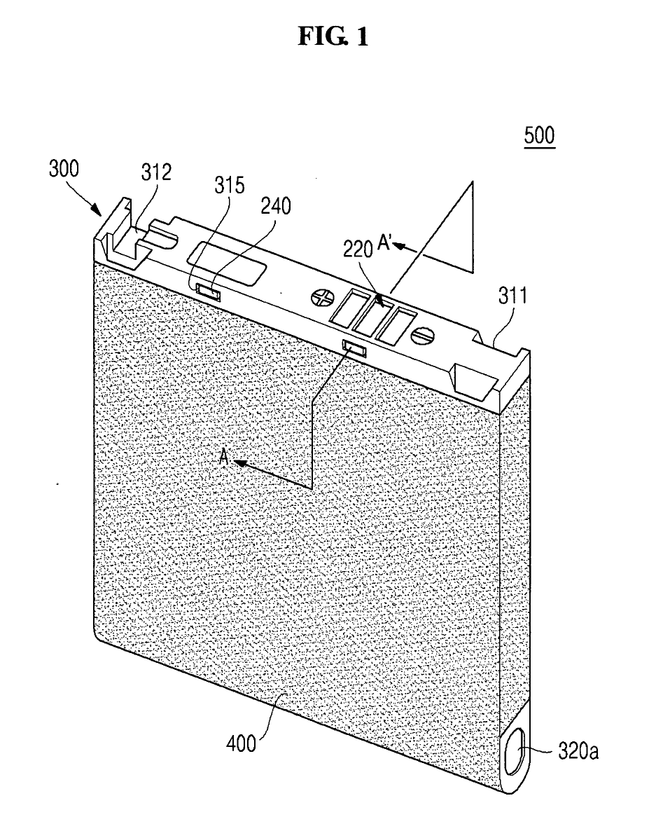

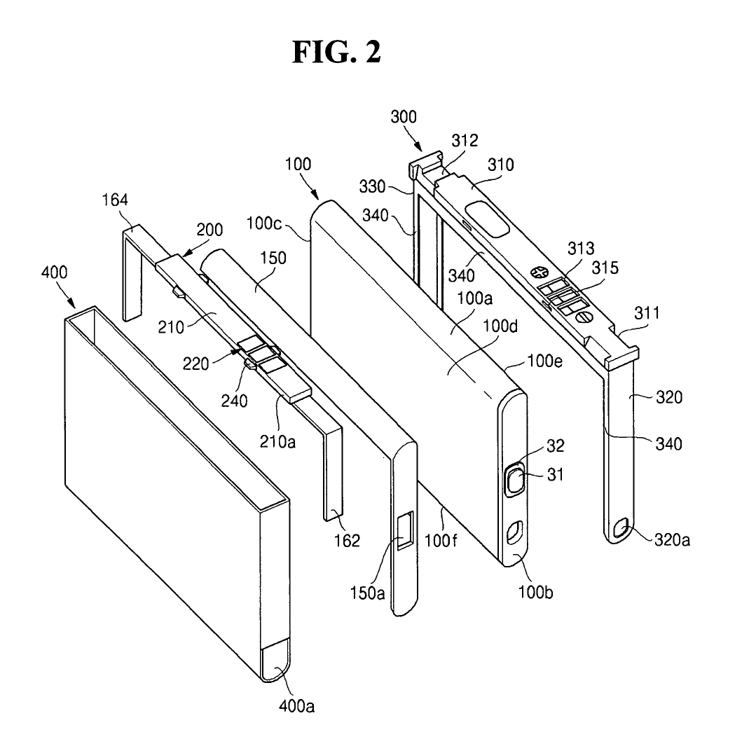

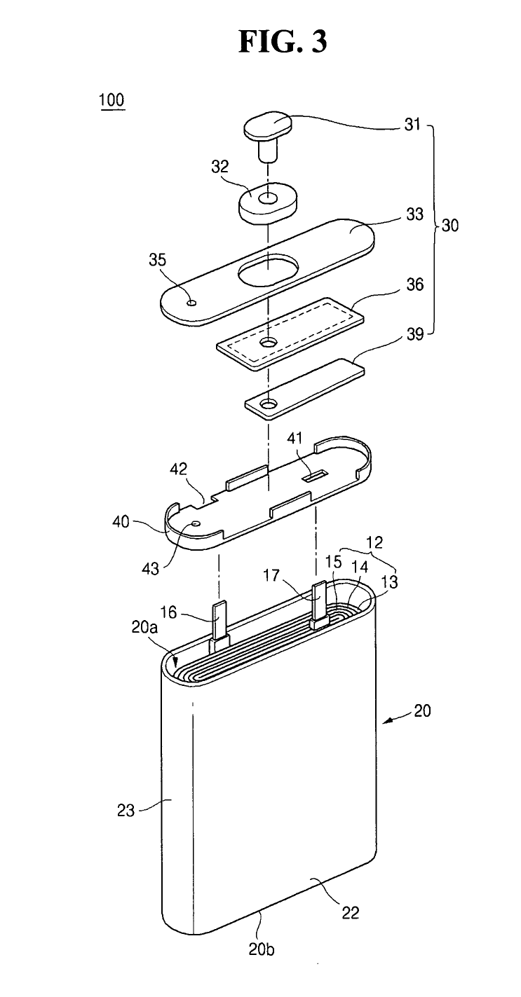

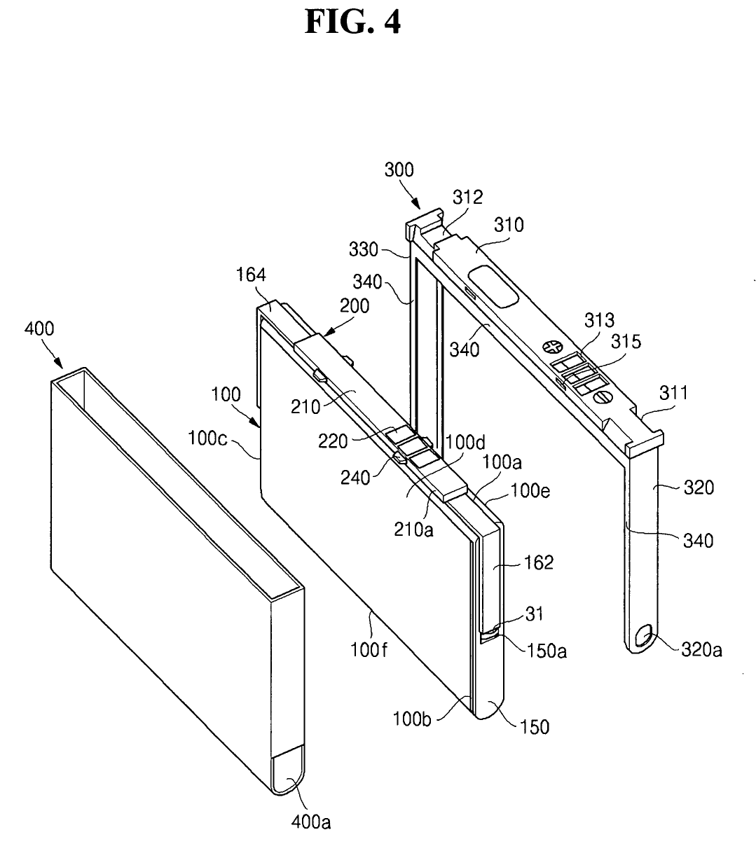

FIG. 1 is a perspective view illustrating a completed battery pack constructed according to one exemplary embodiment of the present invention. FIG. 2 is an exploded perspective view illustrating an exploded battery pack shown in FIG. 1. FIG. 3 is an exploded perspective view illustrating a bare cell of the battery pack shown in FIG. 2. FIG. 4 is a perspective view illustrating a coupled state of a bare cell and a circuit module in the battery pack shown in FIG. 2.

Referring to FIGS. 1 to 3, a battery pack 500 includes a bare cell 100, a circuit module 200, an outer case 300 and a label 400. Battery pack 500 further includes an adherent member formed on circuit module 200 and outer case 300, i.e., protrusion parts 240 and receiving grooves 315.

Bare cell 100 is electrically coupled to circuit module 200 so as to form a core pack, and label 400 is attached after outer case 300 is assembled on the core pack, thereby allowing battery pack 500 to be completed.

Referring to FIG. 3, bare cell 100 included in the core pack is formed by receiving an electrode assembly including a positive electrode plate 13, a negative electrode plate 15 and a separator 14, and an electrolyte in a can 20, and sealing an upper end opening 20a of can 20 with cap assembly 30. Referring to FIG. 2, the outer appearance of bare cell 100 includes an upper surface 100a, a pair of short side surfaces 100b and 100c, a pair of long side surfaces 100d and 100e, and a lower surface 100f Herein, the pair of short side surfaces 100b and 100c of bare cell 100 are narrower side surfaces among side surfaces 100b, 100c, 100d and 100e connected to upper surface 100a of bare cell 100. The pair of long side surfaces 100d and 100e of bare cell 100 are wider side surfaces among side surfaces 100b, 100c, 100d and 101e of bare cell 100.

Electrode assembly 12 is formed by interposing separator 14 between positive electrode plate 13 and negative electrode plate 15 and winding them. Positive electrode tab 16 is coupled to positive electrode plate 13, and negative electrode tab 17 is coupled to negative electrode plate 15. Separator 14 electrically insulates positive electrode plate 13 from negative electrode plate 15, and is formed of porous membrane so that the electrolyte can be passed through.

Can 20 includes a pair of long side surfaces 22 forming the pair of long side surfaces 100d and 100e of bare cell 100, a pair of short side surfaces 23 forming upper surface 100a and lower surface 100f of bare cell 100, and lower surface 20b forming the other short side surface 100c of bare cell 100. Accordingly, can 20 is formed in an approximate box shape, and the upper part thereof is opened so as to form upper end opening 20a thereof. Electrode assembly 12 is inserted into upper end opening 20a of bare cell 100. An upper part of can 20 is sealed with cap assembly 30 so as to prevent leakage of the electrolyte. Can 20 may be formed of metal, preferably, aluminum that is light and ductile or aluminum alloy, but not limited thereto. Preferably, can 20 is formed by a deep drawing method, and long side surfaces 22, short side surfaces 23 and lower surface 20b are integrally formed.

Cap assembly 30 includes a cap plate 33, an insulating plate 36, a terminal plate 39 and an electrode terminal 31. A gasket tube 32 is inserted between electrode terminal 31 and cap plate 33 forming one short side surface 100b of bare cell 100, and electrode terminal 31 is electrically coupled to terminal plate 39. Insulating plate 36 insulates cap plate 33 from terminal plate 39. An electrolyte inlet 35 is formed on one side of cap plate 33. A plug (not shown) is installed so as to seal electrolyte inlet 35 after the electrolyte is injected into electrolyte injection hole 35.

An insulating case 40 is installed on an upper surface of electrode assembly 12 so as to electrically insulate electrode assembly 12 from cap assembly 30 as well as cover an upper end of electrode assembly 12. It is preferable that insulating case 40 is made of poly propylene that is polymer resin having insulation property. A through hole 41 for the extrusion of negative electrode tab 17 is formed on one side of insulating case 40 so that negative electrode tab 17 may be passed through from electrode assembly 12, and another through hole 42 for the extrusion of positive electrode tab 16 is formed at the side edge of insulating case 40, i.e., at a position corresponding to positive electrode tab 16. An electrolyte through-hole 43 may be not formed separately.

Circuit module 200 is electrically coupled to bare cell 100 formed to have the above-described constitution, thereby allowing the core pack to be formed.

Referring to FIG. 2, circuit module 200 includes a printed circuit board 210, an outer terminal 220 installed on printed circuit board 210 and protrusion parts 240 formed on outer side surface 210a of printed circuit board 210.

Printed circuit board 210 is made of a plate-shaped resin, and includes protection circuits such as a circuit for making a charging state uniform by controlling charging and discharging of the battery and a circuit for preventing over-charge or over-discharge, and other related circuits. Circuit elements (not shown) are provided on printed circuit board 210 so as to realize such a circuit.

Circuit module 200 includes electrical coupling terminals (not shown) installed on printed circuit board 210 so that electrode terminal 31 protruded from one short side surface 100b of bare cell 100 and the other short side surface 100c of bare cell 100 are electrically coupled to the electrical coupling terminals, respectively.

First and second lead tabs 162 and 164 are provided so that electrode terminal 31 and the other short side surface 100c of bare cell 100 are electrically coupled to the electrical coupling terminals, respectively. One electrical coupling terminal of printed circuit board 210 electrically coupled to electrode terminal 31 is a negative electrode terminal because electrode terminal 31 functions as a negative electrode. Since the other short side surface 100c of bare cell 100 functions as a positive electrode having polarity opposite to electrode terminal 31, another electrical coupling terminal of printed circuit board 210 electrically coupled to the other short side surface 100c of bare cell 100 is a positive electrode terminal. On the contrary, electrode terminal 31 may function as a positive electrode, and the other short side surface 100c of bare cell 100 may function as a negative electrode constructed according to the exemplary embodiment.

First and second lead tabs 162 and 164 have bent shape of an L letter. First lead tab 162 has a bent part at a corner where upper surface 100a and one short side surface 100b of bare cell 100 meet each other, and second lead tab 164 has a bent part at a corner where upper surface 100a and the other short side surface 100c of bare cell 100 meet.

Referring to FIG. 4, one end of the bent part of first lead tab 162 is electrically connected to electrode terminal 31 by welding or other related process so as to be arranged on one short side surface 100b of bare cell 100 and be electrically insulated from one short side surface 100b, and the other end of the bent part of first lead tab 162 is connected to one electrical coupling terminal installed on printed circuit board 210 by welding or other related process so as to be arranged on upper surface 100a of the bare cell 100 and be electrically insulated from upper surface 100a and also electrically insulated from the surfaces of bare cell 100. Similarly, one end of the bent part of second lead tab 164 is connected to other short side 100c of bare cell 100 by welding or other related process and the other side of the bent part of second lead tab 164 is connected to another electrical coupling terminal installed on printed circuit board 210 by welding or other related process so as to be arranged in an insulated state on upper surface 100a of bare cell 100. Lead tab 164 and lead tab 162 are electrically insulated with each other.

Bare cell 100 is electrically coupled to circuit module 200 by first lead tab 162 and second lead tab 164. First lead tab 162 and second lead tab 164 may be formed of conductive nickel and nickel alloy so that bare cell 100 is electrically coupled to circuit module 200.

Outer terminal part 220 is installed on printed circuit board 210 so that circuit module 200 is electrically coupled to outer electronic devices (not shown), and formed to be exposed to the outside.

The plurality of protrusion parts 240 are formed on an outer side surface 210a of printed circuit board 210. The plurality of the protrusion parts 240 functions as one adherent member for physically coupling outer case 300 to circuit module 200 connected to bare cell 100, so that they are inserted into corresponding receiving grooves 315, i.e., another adherent member of outer case 300 and fixed.

The plurality of the protrusion parts 240 are protruded in tapered shape that becomes narrower from outer side surface 210a of printed circuit board 210 toward outer direction so as to be easily inserted into receiving grooves 315 of outer case 300. Herein, the reason why the plurality of protrusion parts 240 are formed integrally with printed circuit board 210 is to make the plurality of protrusion parts 240 not to be separated from printed circuit board 210 by impact generated during the plurality of protrusion parts 240 are inserted into receiving grooves 315 of outer case 300.

Referring to FIG. 4, four protrusion parts 240 are formed on outer side surface 210a of printed circuit board 210, but not limited thereto. At least one of protrusion parts 240 is formed at a position corresponding to outer terminal part 220 installed on printed circuit board 210 in FIG. 4. That is to resist strong impact generated from a portion of outer terminal part 220 of circuit module 200 and outer case 300 by contacting an electrical terminal of an external device and outer terminal part 220 of battery pack 500 when a completed battery pack 500 is mounted on an outer device by increasing coupling force of outer case 300 and circuit module 200 in which the portion of outer terminal part 220 is formed.

Although not shown in the drawing, circuit module 200 may further include an electric current interruption element, for example, a PTC (Positive Temperature Coefficient) element or a thermal breaker element. The electric current interruption element is formed between printed circuit board 210 and first lead tab 162 located on one side of upper surface 100a of bare cell 100 to prevent firing or explosion of a battery, when the inside of the battery becomes high temperature or a voltage is increased by an over-charge of the battery.

An adherent insulating member 150 is attached on upper surface 100a and one short side surface 100b of the bare cell 100 so as to prevent an unnecessary electrical short between the bare cell 100 and the circuit module 200. The adherent insulating member 150 has a through hole 150a formed in a region corresponding to electrode terminal 31, so that electrode terminal 31 is protruded toward one short side surface 100b of bare cell 100. Adherent insulating member 150 may be any material, for example, a stripe with an adherent property and an electrically insulating property that may insulate and be attached on upper surface 100a and one short side surface 100b of bare cell 100.

The core pack formed by electrically coupling circuit module 200 to bare cell 100 through first and second tabs 162 and 164 is covered by outer case 300 and labeled by label 400, thereby allowing the battery pack to be completed.

Outer case 300 is formed to be an integral injection case by an injection molding method so as to cover upper surface 100a and the pair of short side surfaces 100b and 100c of bare cell 100, and then outer case 300 is assembled in circuit module 200 connected to bare cell 100. In this case, outer case 300 is physically coupled to circuit module 200 connected to bare cell 100 by protrusion parts 240 formed on circuit module 200 and receiving grooves 315 formed on outer case 300.

Outer case 300 is formed integrally with a front surface part 310, a pair of side surface parts 320 and 330, a rim 340 and receiving grooves 315.

More particularly, front surface part 310 of outer case 300 is formed to be in plate shape having size corresponding to upper surface 100a of bare cell 100 provided with circuit module 200. When front surface part 310 is coupled to circuit module 200 connected to bare cell 100, front surface part 310 covers upper surface 100a of bare cell 100. Front surface part 310 includes an window 313 formed at a position corresponding to outer terminal part 220 installed on circuit module 200, thereby allowing outer terminal part 220 to be exposed.

The pair of side surface parts 320 and 330 of outer case 300 are connected to front surface part 310 and formed in plate shape having size corresponding to the pair of short side surfaces 100b and 100c of bare cell 100 so as to cover the pair of short side surfaces 100b and 100c of bare cell 100, when the pair of side surface parts 320 and 330 are coupled to circuit module 200 connected to bare cell 100. A handle part 320a may be formed in a groove type at a lower end of one side surface part 320 of outer case 300, and easily separate battery pack 500 mounted on an external device (not shown).

Rim 340 of outer case 300 is extended from corners of the pair of side surface parts 320 and 330 and front surface part 310 toward along the pair of long side surfaces 100d and 100e of bare cell 100 so as to cover a part of the pair of long side surfaces 100d and 100e, when rim 340 is coupled to circuit module 200 connected to bare cell 100.

Receiving grooves 315 may be formed on rim 340 of outer case 300 so that protrusion parts 240 can be inserted into receiving grooves 315.

Receiving grooves 315 of outer case 300 are another adherent member for physically coupling outer case 300 to circuit module 200 connected to bare cell 100. Accordingly, protrusion parts 240 of circuit module 200 are inserted into receiving grooves 315 of outer case 300 and fixed. Herein, receiving grooves 315 of outer case 300 are formed to have same size as protrusion parts 240 or a little smaller size than protrusion parts 240, so that protrusion parts 240 of circuit module 200 are not easily pulled out.

A locker 311 and a hook 312 formed ranging from front surface part 310 to rim 340 of outer case 300 are arranged on one side and the other side of front surface part 310 of outer case 300. Locker 311 and hook 312 are used for inserting battery pack 500 into an external device in right direction.

After outer case 300 is formed as an integral injection case in advance by an injection molding method, outer case 300 coupled to bare cell 100 connected to circuit module 200 may realize more compact battery pack than an outer case including an outer cover assembled on both short side surface of a bare cell connected to a protection circuit module, and a resin member (not shown) formed on an upper surface 100a of bare cell 100 by a hot-melt method using hot-melt resin in a related art battery pack.

Label 400 is attached so as to cover side surfaces 100b, 100c, 100d and 101e of bare cell 100 and lower surface 100f after covering circuit module 200 connected to bare cell 100 with outer case 300. Accordingly, coupling force between outer case 300 and the core pack formed by being connected to bare cell 100 and circuit module 200 is increased, so that the completed battery pack 500 may be protected from outer shock. Herein, a through hole 400a on label 400 is formed on a region corresponding to handle part 320a formed on outer case 300 so that handle part 320a may be exposed.

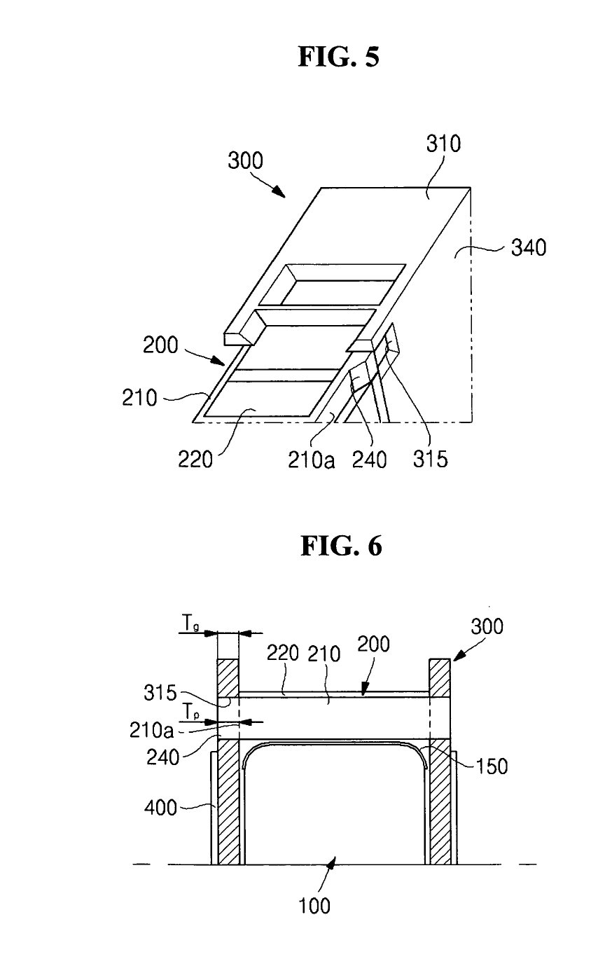

Referring to FIGS. 5 and 6, coupled structure of outer case 300 and circuit module 200 connected to bare cell 100 will be explained hereinafter.

FIG. 5 is a partial perspective view explaining coupling of the circuit module and the outer case shown in FIG. 2. FIG. 6 is a partial cross-sectional view illustrating apart of a coupling section of the circuit module and the outer case taken cutting along the line A-A′ in FIG. 1.

Referring to FIGS. 5 and 6, physical coupling of outer case 300 and circuit module 200 connected to bare cell 100 is formed by coupling protrusion parts 240 of circuit module 200 to receiving grooves 315 of outer case 300, i.e., coupling of locking structure.

More particularly, circuit module 200 connected to bare cell 100 is tightly coupled to outer 1 case 300 by inserting protrusion parts 240 of circuit module 200 into receiving grooves 315 of outer case 300. Accordingly, circuit module 200 and outer case 300 may be prevented from being separated from each other by external force. Thickness (Tp) of protrusion parts 240 of circuit module 200 protruded from outer side surface 210a of printed circuit board 210 toward outer direction is shown in the drawing to be the same as thickness (Tg) of receiving grooves 315 of outer case 300, but the protrusion thickness (Tp) may be in the ranges of ⅔ to 3/3 of the thickness (Tg) of receiving grooves 315. When the thickness (Tp) of protrusion parts 240 is smaller than ⅔ of the thickness (Tg) of receiving grooves 315, the coupling force of circuit module 200 and outer case 300 becomes weak under a strong external impact, so that circuit module 200 may be separated from outer case 300. When the thickness (Tp) of protrusion parts 240 is larger than the thickness (Tg) of receiving grooves 315, the protrusion parts 240 is protruded toward the outside of battery pack 500, so that battery pack 500 may not be evenly mounted on an outer device.

As described above, battery pack 500 is completed by coupling outer case 300 to upper surface 100a of bare cell 100 and the both short side surfaces 100b, 100c of bare cell 100 connected to circuit module 200 by the adherent member after integrally forming outer case 300 in advance by the injection molding method. Accordingly, battery pack 500 may be more compact, and the coupling force between circuit module 200 and outer case 300 may be stronger than a contemporary battery pack assembling both short side surfaces of a bare cell connected to a protection circuit module and covering an upper surface of the bare cell with a resin member formed by a hot-melting method.

Further, battery pack 500 may reduce defective outer appearance generated from the related art battery pack using the hot-melting method to form the outer case, simplify complicated processes and reduce material costs of hot-melt resin.

Further, battery pack 500 is formed by separately injection molding outer case 300 and assembling outer case 300 with bare cell 100 where circuit module 200 is coupled. Accordingly, although defective outer appearance of outer case 300 is generated, only defective outer cases may be disused. Hence, when a resin member formed between a bare cell and a protection circuit module so as to fix the bare cell and the protection circuit module has the defective outer appearance, battery pack 500 may reduce a defective ratio of products by preventing the entire battery pack itself from being disused. Thus, production yield of battery pack 500 may be improved.

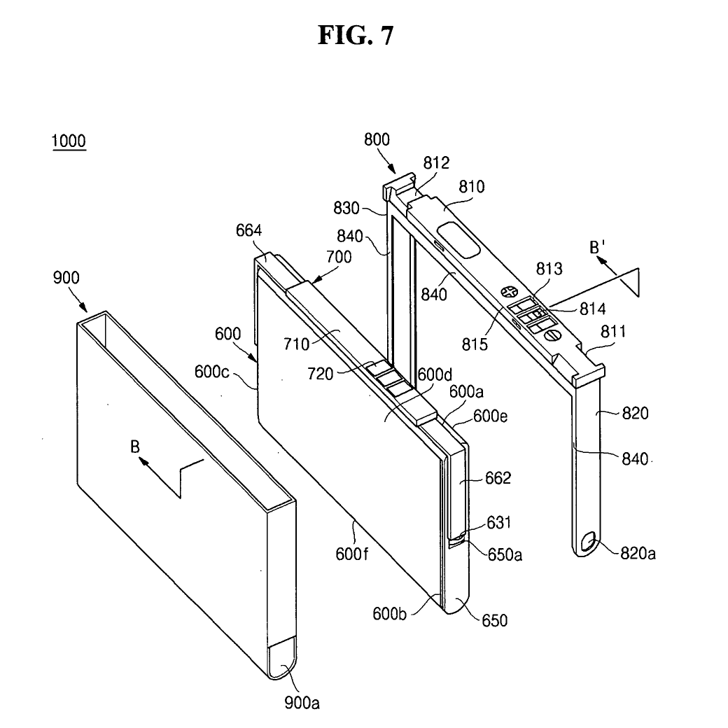

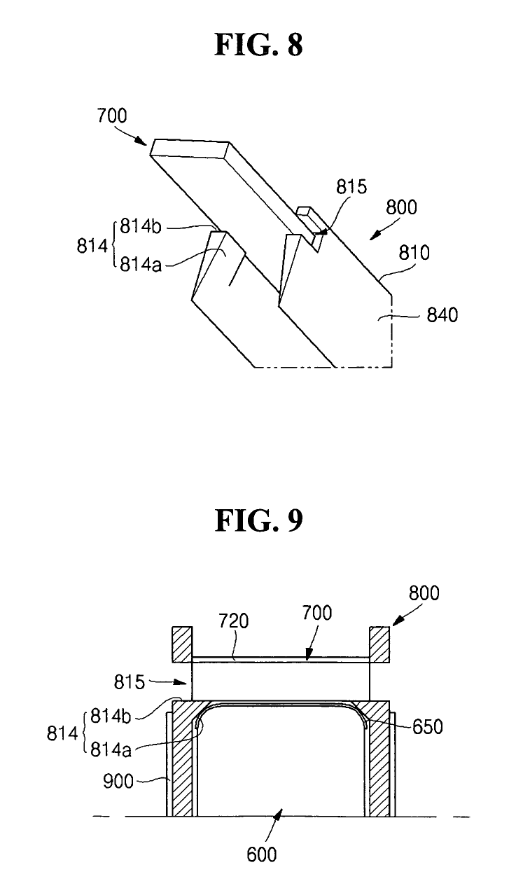

FIG. 7 is a partial exploded perspective view illustrating the battery pack according to another exemplary embodiment of the present invention. FIG. 8 is a partial perspective view explaining coupling of the circuit module and the outer case of FIG. 8. FIG. 9 is a partial cross-sectional view illustrating a part of a coupling section of the circuit module and the outer case taken along B-B′ line in FIG. 7.

A battery pack 1000 constructed according to another exemplary embodiment of the present invention has the same component and function as battery pack 500 constructed according to one exemplary embodiment of the present invention as stated above, except that the adherent member physically coupling an outer case to a circuit module connected to a bare cell are formed only on the outer case.

Referring to FIGS. 7 to 9, battery pack 1000 includes a bare cell 600, a circuit module 700, an outer case 800 and a label 900. Battery pack 1000 further includes an adherent member, i.e., a tapered part 814 and receiving space 815 formed in an inner side of outer case 800.

Bare cell 600 is electrically coupled to circuit module 700 to form a core pack, and then core pack, where label 900 is attached, is assembled with outer case 800 and is attached to label 900, thereby allowing battery pack 1000 to be completed.

Bare cell 600 and label 900 are the same as bare cell 100 and label 400 of battery pack 500 as shown in FIGS. 1-6 constructed according to one exemplary embodiment of the present invention, and thus duplicated explanation will be omitted. Only the difference will be described in details.

Circuit module 700 shown in FIG. 7 includes a printed circuit board 710, an circuit element (not shown) forming a circuit of printed circuit board 710 and an outer terminal part 720 in the same manner of FIG. 2, except protrusion parts 240, i.e., one of adherent members formed on circuit module 200 shown in FIG. 2.

Printed circuit board 710, the circuit element (not shown) and outer terminal part 720 of circuit module 700 are the same as printed circuit board 210, the circuit element (not shown) and outer terminal part 220, and thus duplicated explanation will be omitted.

Circuit module 700 is electrically coupled to bare cell 600 by a first lead tab 662 and a second lead tab 664, and physically coupled to an outer case 800.

Outer case 800 is formed to be an integral injection case by an injection molding method so as to cover an upper surface 600a and a pair of short side surfaces 600b and 600c of bare cell 600, and then outer case 800 is assembled in circuit module 700 connected to bare cell 600.

Outer case 800 includes a front surface part 810, a pair of side surface parts 820 and 830 and an extended surface part 840. Further, outer case 800 includes a tapered part 814 and a receiving space 815 formed in the inner side thereof. Front surface part 810, the pair of side surface parts 820 and 830, and rim 840 of outer case 800 are the same as front surface part 310, the pair of side surface parts 320 and 330, and rim 340 of outer case 300 respectively as shown in FIG. 4, and thus duplicated explanation will be omitted.

Tapered part 814 and receiving space 815 formed in the inner side of outer case 800 function as the adherent member to physically couple outer case 800 to circuit module 700 connected to bare cell 600.

Referring to FIGS. 8 and 9, tapered part 814 is formed in protruded structure on a front end of outer case 800 in direction that circuit module 700 is inserted into outer case 800, more particularly, in an inner side of extended surface part 840 adjacent to front surface part 810. Tapered part 814 includes an inclined surface 814a and a plane 814b.

Inclined surface 814a of tapered part 814 guides circuit module 700 when circuit module 700 is inserted into outer case 800, and plane 814b fixes circuit module 700 after circuit module 700 is inserted into outer case 800. A plurality of tapered parts may be formed in the inner side of extended surface part 840 adjacent to front surface 810 of outer case 800, but not limited thereto. At least one tapered part 814 is formed at a position corresponding to outer terminal part 720 installed on printed circuit board 710. That is to resist strong impact generated from a portion of outer terminal part 720 of circuit module 700 and outer case 800 by contacting an electrical terminal of an outer device and outer terminal part 720 of battery pack 1000 when a completed battery pack 1000 is mounted on an outer device by increasing coupling force of outer case 800 and circuit module 700 in which the portion of outer terminal part 720 is formed.

Receiving space 815 is formed on a rear end of outer case 800 in direction that circuit module 700 is inserted into outer case 800, i.e., an upper part of tapered part 814. In other words, receiving space 815 is formed in an upper part of an inner side of outer case 800 by tapered part 814 formed in a protruded shape in the inner side of outer case 800. Circuit module 700 passing though tapered part 814 is inserted into receiving space 815 and fixed to be mounted in receiving space 815. Accordingly, circuit module 700 may be tightly coupled to outer case 800, so that it may be prevented circuit module 700 is separated from outer case 800 by outer force.

As described above, after outer case 800 is formed as an integral injection case in advance by an injection molding method, outer case 800 coupled to bare cell 600 connected to circuit module 700 may realize more compact battery pack than an outer case including an outer cover assembled on both short side surface of a bare cell connected to a protection circuit module, and a resin member formed on an upper surface of the bare cell by a hot-melting method using hot-melt resin in a related art battery pack.

Reference number 812 refers to a hook which has the same functionality of hook 312 as shown in FIG. 2; reference number 813 refers to a window which has the same functionality of window 313 as shown in FIG. 2; Reference number 811 refers to a locker which has the same functionality of locker 311 as shown in FIG. 2; Reference number 820a refers to a handle part which has the same functionality of handle part 320a as shown in FIG. 2; Reference number 600d and 600e refer to a pair of long side surfaces of bare cell 600 which has the same functionality of long side surfaces 100d and 100e as shown in FIG. 2; Reference number 600f refers to a lower side surface of bare cell 600 which has the same functionality of lower side surface 100f as shown in FIG. 2; Reference number 900a refers to a through hole which has the same functionality of through hole 400a as shown in FIG. 2; Reference number 631 refers to an electrode terminal which has the same functionality of electrode terminal 31 as shown in FIG. 2; Reference number 650a refers to a through hole which has the same functionality of through hole 150a as shown in FIG. 2; Reference number 650 refers to a adherent insulating member which has the same functionality of adherent insulating member 150 as shown in FIG. 2.

The battery pack constructed according the present invention produces the following effects.

First, the battery pack may increase the coupling strength of the protection circuit module and the outer case, and realize the compact battery pack by physically coupling the protection circuit module coupled to the bare cell and the integral outer case by the adherent member.

Second, the battery pack may increase the production yield by reducing the defective ratio of the battery pack than the contemporary battery pack forming the outer case so as to fix the protection circuit module on the bare cell by the hot-melt method, simplify the complicated manufacturing processes caused by the hot-melt method, and reduce the material costs of the hot-melt resin by performing the integral outer case by the injection molding method so as to assemble the integral outer case on the circuit module coupled to the bare cell.

Third, the battery pack may reduce the defective ratio of the products by preventing the battery pack itself from being disused, when the resin member of the related art battery pack formed between the bare cell and the protection circuit module so as to fix the bare cell and the protection circuit module has the defective outer appearance, thereby allowing the production yield of the battery pack to be improved.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. A battery pack, comprising:
a bare cell;
a circuit module arranged on an upper surface of the bare cell and electrically coupled to the bare cell;
an outer case integrally formed so as to simultaneously cover a pair of short side surfaces and the upper surface of the bare cell including the circuit module, and coupled to the circuit module; and
a label attached to the pair of the short side surfaces, a pair of long side surfaces and a lower surface of the bare cell.

2. The battery pack of claim 1, in which the circuit module is coupled to the outer case by an adherent member, the adherent member comprises:
a plurality of protrusion parts formed on the circuit module, and
a plurality of receiving grooves formed on the outer case corresponding to the protrusion parts of the circuit module, so that the plurality of the protrusion parts of the circuit module are inserted in the plurality of the receiving grooves.

3. The battery pack of claim 2, in which the circuit module comprises:
a plate-shaped printed circuit board,
an outer terminal part installed to the printed circuit board so as to be exposed to the outside, and
the plurality of the protrusion parts formed on an outer side surface of the printed circuit board.

4. The battery pack of claim 3, in which at least one of the plurality of the protrusion parts is located so as to correspond to a region where the outer terminal part is located.

5. The battery pack of claim 3, in which the plurality of the protrusion parts are protruded in tapered shape from the outer side surface of the printed circuit board toward outer direction.

6. The battery pack of claim 3, in which a thickness of the plurality of the protrusion parts protruded from the outer side surface of the printed circuit board to an out side is in a range of ⅔ to 3/3 of thickness of the receiving grooves formed in the outer case.

7. The battery pack of claim 2, in which the outer case comprises:
a front surface part formed to have size corresponding to the upper surface of the bare cell provided with the circuit module,
side surface parts connected to the front surface part and formed to have size corresponding to the pair of the respective short side surfaces of the bare cell,
an extended surface part formed to be extended from edges of the front surface part and the side surface parts so as to cover the pair of the long side surfaces of the bare cell, and
a plurality of receiving grooves formed at a position corresponding to the protrusion parts of the circuit module in an inner side of the extended surface part adjacent to the front surface part.

8. The battery pack of claim 1, in which the circuit module is coupled to the outer case by the adherent member formed in an inner side of the outer case, and the adherent member comprise:
a plurality of tapered parts located in a front end of the outer case in inserted direction of the circuit module so as to guide the circuit module, and
receiving space located in a rear end of the outer case so as to fix the circuit module.

9. The battery pack of claim 8, in which the circuit module comprises:
a plate-shaped printed circuit board, and
an outer terminal part installed on the printed circuit board so as to be exposed to the outside.

10. The battery pack of claim 9, in which at least one of the tapered parts is located on a portion of the outer terminal part included in the circuit module.

11. The battery pack of claim 8, in which the outer case comprises:
the front surface part formed to have the size corresponding to the upper surface of the bare cell provided with the circuit module,
the side surface part connected to the front surface part and formed to have the size corresponding to the pair of the respective short side surfaces of the bare cell,
the extended surface part formed to be extended from the edges of the front surface part and the side surface part so as to cover the pair of the long side surfaces of the bare cell,
the plurality of tapered parts formed to have an inclined surface and a plane connected to the inclined surface in an inner side of the extended surface part adjacent to the front surface part, and
the receiving space formed on an upper part of the tapered parts in an inner side of the extended surface part adjacent to the front surface part.

12. The battery pack of claim 1, further comprising an adherent insulating member attached on the upper surface of the bare cell so as to prevent an electrical short between the bare cell and the circuit module.

13. The battery pack of claim 1, in which the bare cell is electrically coupled to the circuit module by one electrical connecting terminal installed on the circuit module,
a first lead tab electrically coupling a protruded electrode terminal insulated from one of a pair of short side surfaces of the bare cell, and
a second lead tab electrically coupling another electrical connecting terminal installed on the circuit module to the other short side surface of the bare cell.

14. The battery pack of claim 1, in which the outer case comprises a handle part formed in a lower end of one side surface part corresponding to one of the pair of the short side surfaces of the bare cell.

15. The battery pack of claim 14, in which the label comprises a through hole formed on a region corresponding to the handle part.
